(19) United States
(12) Patent Application Publication
(10) Pub. No.: US 2025/0121864 A1
(43) Pub. Date: Apr. 17, 2025

(54) IMAGING AND MONITORING OF HIGH-SPEED OBJECTS

(71) Applicant: Delta Thermal Inc., Tucson, AZ (US)

(72) Inventors: Andrew Griffis, Tucson, AZ (US); Charles Edward Fleder, Tucson, AZ (US); Cloud Cray, Tucson, AZ (US)

(21) Appl. No.: 18/913,601

(22) Filed: Oct. 11, 2024

Related U.S. Application Data
(60) Provisional application No. 63/589,596, filed on Oct. 11, 2023.

(51) Int. Cl. B61L 25/02; B61L 27/57; G01S 13/58; G01S 13/86; G06T 5/80; G06T 7/00; H04N 23/695

(52) U.S. Cl. CPC B61L 25/021; G01S 13/58; G01S 13/865; G01S 13/867; G06T 5/80; G06T 7/0002; H04N 23/695; B61L 27/57; G06T 2207/10028; G06T 2207/30248

(57) ABSTRACT

A stationary sensing system configured to analyze a passing high-velocity object. The system includes a stationary housing, a velocity sensor, and a localization sensor. The system further includes an optical assembly including uncooled imaging device(s) having a moving field of view, configured to capture images within the collective moving field of view, and a controller coupled to the uncooled imaging devices, configured to accept a velocity and a location, actuate the uncooled imaging devices to lock the field of view to the location of the object rotate it at a velocity matching the velocity of the object, and actuate the uncooled imaging devices to capture images within the moving field of view. The system further includes a computing device communicatively coupled to the optical assembly, configured to accept the images from the uncooled imaging devices and analyze properties of the object based on the images.

### CROSS-REFERENCES TO RELATED APPLICATIONS

This application is a non-provisional and claims benefit of U.S. Provisional Application No. 63/589,596 filed Oct. 11, 2023, the specification of which is incorporated herein in its entirety by reference.

### FIELD OF THE INVENTION

The present invention is directed to an imaging system configured to track and monitor the properties of a high-speed object.

### BACKGROUND OF THE INVENTION

For train cars traveling on railroads, it is important to monitor the wheels of said train cars and make sure that they are functioning properly. Failure to detect a malfunction or overheating can be disastrous, in some cases resulting in a crash that can lead to massive financial losses and potentially the loss of life. Certain imaging systems exist for monitoring the health of train car wheels, but these prior systems lack efficiency, simplicity and affordability. For example, trains may be stopped at stations along the railroad for the wheels to be analyzed through manual or computerized means. While this can prevent damages, this also causes delays which could cascade into supply chain issues down the line. Automated wheel imaging systems exist that can quickly analyze wheels as the train passes by without requiring it to stop, but these devices tend to be expensive and complicated, which can produce cumbersome error rates. These prior image-oriented systems implement track-based point sensors to produce an image-like output or a cooled mid-wave infrared high-speed camera which can cost up to 100,000 dollars per unit, plus the recurring maintenance of a vacuum based cooling apparatus—these are not amenable to low maintenance, harsh environments. Furthermore, these devices are generally placed in remote locations as this is where automated monitoring is most needed, making them inconvenient to repair and perform maintenance on. Thus, there exists a present need for a cost-efficient and durable automated imaging system capable of monitoring the health of train car wheels.

### BRIEF SUMMARY OF THE INVENTION

It is an objective of the present invention to provide compact, cost effective systems that allow for an imaging system configured to track and monitor properties of a high-speed object, as specified in the independent claims. Embodiments of the invention are given in the dependent claims. Embodiments of the present invention can be freely combined with each other if they are not mutually exclusive.

The present invention features a stationary sensing system configured to analyze a passing high-velocity object. In some embodiments, the system may comprise a stationary housing, a velocity sensor configured to detect a velocity of the object, and a localization sensor configured to detect a location of the object. The system may further comprise an optical assembly disposed within the stationary housing, communicatively coupled to the velocity sensor and the localization sensor. The assembly may comprise one or more uncooled imaging devices having a moving field of view, configured to capture one or more images within the collective moving field of view, and a controller operatively coupled to the one or more uncooled imaging devices, configured to accept the velocity and the location, actuate the uncooled imaging devices to lock the field of view to the location of the object rotate it at a velocity matching the velocity of the object, and actuate the uncooled imaging devices to capture images within the moving field of view. The system may further comprise a computing device communicatively coupled to the optical assembly, configured to accept the images from the uncooled imaging devices and analyze properties of the object based on the images.

One of the unique and inventive technical features of the present invention is the use of uncooled infrared cameras in an automated high-speed object-tracking system. Without wishing to limit the invention to any theory or mechanism, it is believed that the technical feature of the present invention advantageously provides for cost-efficient monitoring of objects traveling at high speeds without the need for constant cooling and maintenance. None of the presently known prior references or work has the unique inventive technical feature of the present invention.

Furthermore, the inventive technical features of the present invention contributed to a surprising result. One of ordinary skill in the art would not expect that uncooled cameras could be used for an automated high-speed object imaging system due to the rapid operations required for the process. Surprisingly, the present invention is able to implement uncooled imaging devices paired with a localizing sensor system and a motorized assembly such that the system is able to effectively image high-speed objects without the need for a vacuum-sealed cooling apparatus. Thus, the inventive technical feature of the present invention contributed to a surprising result.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a schematic diagram of the system of the present invention for imaging and monitoring high-speed objects.

FIG. 1B shows a schematic diagram of an embodiment of the optical assembly of the present invention, showing an imaging device coupled to a rotating motor.

FIG. 1C shows a schematic diagram of an alternate embodiment of the optical assembly of the present invention, showing an imaging device in line with a mirror coupled to a rotating motor.

FIG. 2 shows a schematic diagram of an alternate embodiment of the optical assembly of the present invention comprising multiple mirror-motor assemblies in line with an imaging device and light source to constitute a simulator for the invention.

FIG. 3 shows a flow chart of a process for the imaging system of the present invention syncing with a wheel of a train car as well as subsequent wheels of the same train car to produce image-object lists for an entire sequence of rail cars.

FIG. 4 shows another alternate embodiment of the optical assembly of the present invention, showing a plurality of imaging devices, a plurality of optical elements, and multiple optical elements coupled to a motor to constitute simultaneous tracking of distinct objects with one axis of rotation.

FIG. 5 shows an example diagram of the arrangement of detector and imager fields of view in relation to a track with passing train for capture and communication with the invention.

FIG. 6 shows a schematic diagram of a possible railcar component geometry in relation to the imaging system of the present invention for tracking consecutive wheels of a train car.

FIG. 7 shows a schematic diagram of the data flows associated with the control computer of the present invention and its sensing constituents.

FIG. 8 shows a ray trace and element placement diagram of the optical slip ring layout of the present invention.

FIG. 9 shows a model rendering of the optical slip ring layout of the present invention.

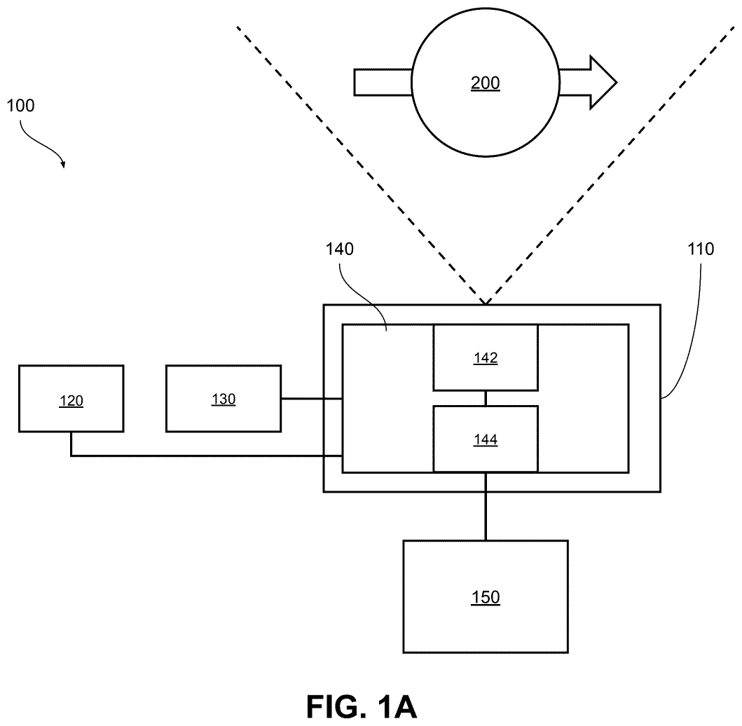

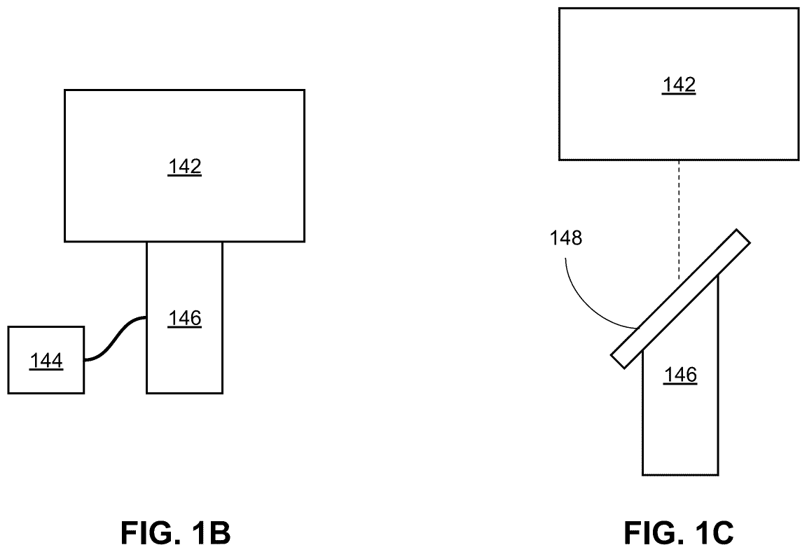

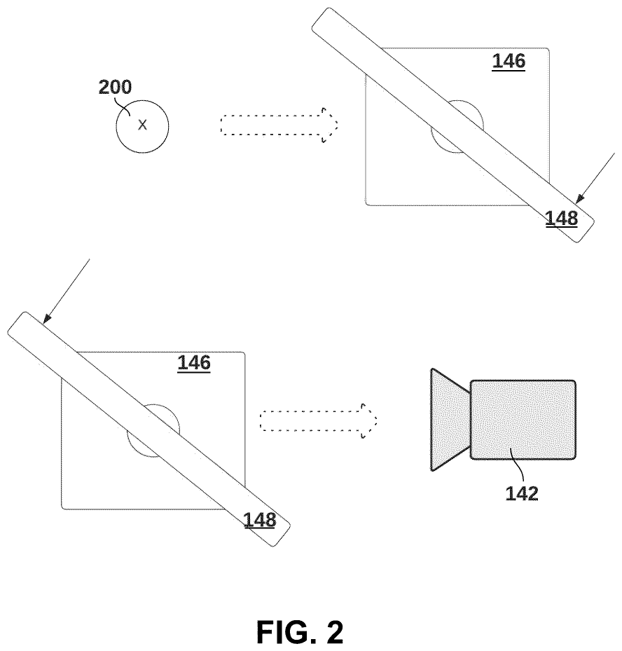

### DETAILED DESCRIPTION OF THE INVENTION

Following is a list of elements corresponding to a particular element referred to herein:
100 system
110 stationary housing
120 velocity sensor
130 localization sensor
140 optical assembly
142 imaging device
144 controller
146 motor
148 mirror
150 computing device
200 object
301 radar sensor
302 computing device
303 time-of-arrival estimator
304 lidar sensor
305 first wheel
306 first wheel acquisition planner
307 next wheel acquisition planner
308 gimbal trajectory
309 encoder
310 servo velocity control
311 servo
501 narrow beamwidth
502 narrow field of view
503 connection between stations
504 cloud services provider
505 wireless connection
506 wheel passage

The term “radar sensor” is defined herein as a system for detecting the presence, direction, distance, and speed of objects, by sending out pulses of high-frequency electromagnetic waves that are reflected off the object back to the source.

The term “lidar sensor” is defined herein as a detection system that works on the principle of radar, but uses light from a laser.

The term “barrel distortion” is defined herein as a type of defect in optical or electronic images in which vertical or horizontal straight lines appear as convex curves.

The term “root-mean-square wavefront error” is defined herein as a quantitative measure of wavefront aberration.

The term “modulation transfer function” is defined herein as a determination of how much contrast in the original object is maintained by the detector.

The term “field stop” is defined herein as an aperture which limits the field of view in optical systems.

The term “collective moving field of view” is defined herein as an area optically in-line with one or more imaging devices (e.g. cameras) capable of translating, rotating, or a combination thereof. The imaging devices are capable of capturing images of the area optically in-line with said imaging devices. The area captured by the one or more imaging devices may be captured as a plurality of images stitched into a panoramic image.

The present invention features a stationary sensing system (100) configured to analyze a passing high-velocity object (200). In some embodiments, the system (100) may comprise a stationary housing (110). The system (100) may further comprise a velocity sensor (120) configured to detect a velocity of the object (200). The system (100) may further comprise a localization sensor (130) configured to detect a location of the object (200). The system (100) may further comprise an optical assembly (140) disposed within the stationary housing (110), communicatively coupled to the velocity sensor (120) and the localization sensor (130).

In some embodiments, the assembly (140) may comprise one or more uncooled imaging devices (142) having a collective moving field of view, configured to capture one or more images within the collective moving field of view. The assembly (140) may further comprise a controller (144) operatively coupled to the one or more uncooled imaging devices (142), configured to accept the velocity from the velocity sensor (120) and the location from the localization sensor (130), actuate the one or more uncooled imaging devices (142) such that the collective moving field of view of the one or more uncooled imaging devices (142) synchronizes with the location of the passing object (200) and rotates at a tangential velocity matching the velocity of the object (200), and actuate the one or more uncooled imaging devices (142) to capture the one or more images within the collective moving field of view such that the one or more images capture the object (200). The system (100) may further comprise a computing device (150) communicatively coupled to the optical assembly (140), configured to accept the one or more images from the one or more uncooled imaging devices (142) and analyze one or more properties of the object (200) based on the one or more images.

In some embodiments, the one or more uncooled imaging devices (142) may comprise one or more thermal cameras, one or more red-green-blue (RGB) cameras, or a combination thereof. In some embodiments, the one or more uncooled imaging devices (142) may comprise a plurality of uncooled imaging devices arranged in series, wherein rotating the collective moving field of view comprises actuating each uncooled imaging device of the plurality of uncooled imaging devices in series. In some embodiments, the one or more uncooled imaging devices (142) may comprise a single uncooled imaging device. The system (100) may further comprise a motor (146). The controller (144) may be further configured to actuate the motor (146) to rotate the collective moving field of view.

In some embodiments, the motor (146) may be operatively coupled to the single uncooled imaging device and may be configured to rotate the single uncooled imaging device. In some embodiments, the system (100) may further comprise one or more optical elements (148) optically in-line with the single uncooled imaging device. The motor (146) may be operatively coupled to the one or more optical elements (148) and may be configured to rotate the one or more optical elements (148). In some embodiments, the one or more optical elements (148) may comprise a Coudé optical arrangement (“optical slip ring”). In some embodiments, the one or more optical elements may comprise one or more mirrors, lenses, filters, diffraction gratings, prisms, or a combination thereof. In some embodiments, the velocity sensor (120) may comprise a radar sensor. In some embodiments, the localization sensor (130) may comprise a lidar sensor. In some embodiments, the computing device (150) may be further communicatively coupled to one or more additional stationary sensing systems. The computing device (150) may be further configured to accept one or more additional images of the object (200) from the one or more additional stationary sensing systems and analyze the one or more properties based on the one or more images and the one or more additional images. In some embodiments, the computing device (150) may be further configured to correct the one or more images for barrel distortion, distortions in focal length and field of view in an x direction, distortion in focal length and field of view in a y direction, root-mean-square wavefront errors, modulation transfer function degradation, or a combination thereof.

In some embodiments, especially when system longevity is less of a concern, the optical slip ring may be replaced with a traditional electrical wired slip ring assembly and a camera placed on the moving platform with signals and power passing in and out through this wired slip ring component, such that a Coude' optic is not required.

The present invention features a stationary sensing system (100) configured to analyze a passing high-velocity object (200). In some embodiments, the system (100) may comprise a stationary housing (110). The system (100) may further comprise a velocity sensor (120) configured to detect a velocity of the object (200). The system (100) may further comprise a localization sensor (130) configured to detect a location of the object (200). The system (100) may further comprise an optical assembly (140) disposed within the stationary housing (110), communicatively coupled to the velocity sensor (120) and the localization sensor (130).

The assembly (140) may comprise an uncooled imaging device (142) having a moving field of view, configured to capture one or more images within the moving field of view. The assembly (140) may further comprise a motor (146) operatively coupled to the uncooled imaging device (142), configured to rotate the uncooled imaging device (142). The assembly (140) may further comprise a controller (144) operatively coupled to the uncooled imaging device (142), configured to accept the velocity from the velocity sensor (120) and the location from the localization sensor (130), actuate the motor (146) to rotate the uncooled imaging device (142) such that the moving field of view of the uncooled imaging device (142) locks to the location of the object (200) and rotates at a velocity matching the velocity of the object (200), and actuate the uncooled imaging device (142) to capture the one or more images within the moving field of view such that the one or more images capture the object (200). The system (100) may further comprise a computing device (150) communicatively coupled to the optical assembly (140), configured to accept the one or more images from the uncooled imaging device (142) and analyze one or more properties of the object (200) based on the one or more images.

In some embodiments, the uncooled imaging device (142) may comprise a thermal camera, a red-green-blue (RGB) camera, or a combination thereof. In some embodiments, the velocity sensor (120) may comprise a radar sensor. In some embodiments, the localization sensor (130) may comprise a lidar sensor. In some embodiments, the computing device (150) may be further communicatively coupled to one or more additional stationary sensing systems. The computing device (150) may be further configured to accept one or more additional images of the object (200) from the one or more additional stationary sensing systems and analyze the one or more properties based on the one or more images and the one or more additional images. In some embodiments, the computing device (150) may be further configured to correct the one or more images for barrel distortion, distortions in focal length and field of view in an x direction, distortion in focal length and field of view in a y direction, root-mean-square wavefront errors, modulation transfer function degradation, or a combination thereof.

The present invention features a stationary sensing system (100) configured to analyze a passing high-velocity object (200). In some embodiments, the system (100) may comprise a stationary housing (110). The system (100) may further comprise a velocity sensor (120) configured to detect a velocity of the object (200). The system (100) may further comprise a localization sensor (130) configured to detect a location of the object (200). The system (100) may further comprise an optical assembly (140) disposed within the stationary housing (110), communicatively coupled to the velocity sensor (120) and the localization sensor (130).

The assembly (140) may comprise an uncooled imaging device (142) having a moving field of view, configured to capture one or more images within the moving field of view. The assembly (140) may further comprise a plurality of optical elements (148) optically in-line with the uncooled imaging device (142), in a Coude arrangement. The assembly (140) may further comprise a motor (146) operatively coupled to the plurality of optical elements (148), configured to rotate the plurality of optical elements (148). The assembly (140) may further comprise a controller (144) operatively coupled to the uncooled imaging device (142), configured to accept the velocity from the velocity sensor (120) and the location from the localization sensor (130), actuate the motor (146) to rotate the plurality of optical elements (148) such that the moving field of view of the uncooled imaging device (142) locks to the location of the object (200) and rotates at a velocity matching the velocity of the object (200), and actuate the uncooled imaging device (142) to capture the one or more images within the moving field of view such that the one or more images capture the object (200). In some embodiments, the plurality of optical elements may comprise one or more mirrors, lenses, filters, diffraction gratings, prisms, or a combination thereof.

The system (100) may further comprise a computing device (150) communicatively coupled to the optical assembly (140), configured to accept the one or more images from the uncooled imaging device (142) and analyze one or more properties of the object (200) based on the one or more images. In some embodiments, the velocity sensor (120) may comprise a radar sensor. In some embodiments, the localization sensor (130) may comprise a lidar sensor.

In some embodiments, the computing device may be configured to analyze the properties of the object being observed by the imaging device(s). The properties may comprise a temperature, a heat signature, visual imperfections, a structural property of a moving body, a multi-object physical observable relationship that characterizes the passing ensemble, e.g., a sequence of rail cars and their railcar components, or a combination thereof. In some embodiments, the velocity, acceleration, and location of the object gatherer for imaging said object may be used for additional processing. In some embodiments, the computing device may be configured to connect an instance of an additional stationary sensing station (stationary housing, velocity sensor, localization sensor, and optical assembly) with another instance at another point on the railroad, on an adjacent railroad, or a combination thereof. In some embodiments, the object analyzed by the present invention may comprise a wheel of a vehicle (e.g. a train, a car, a truck, etc.). In some embodiments, the object analyzed by the present invention may comprise an airborne high-speed object (e.g. a plane, a jet, a missile, etc.).

In some embodiments, each instance of the device of the present invention may comprise its own computing device for processing data. In some embodiments, a plurality of instances of the device of the present invention may be connected to one or more edge computing devices such that the plurality of instances are connected by a network. In some embodiments, the one or more edge computing devices may be communicatively coupled to a cloud computing system for compiling data from all instances of the system of the present invention in a given region.

In some embodiments, the stationary housing may comprise a segmented window design comprising a plurality of windows. In some embodiments, each window of the plurality of windows may be rotated at a different angle relative to the area being observed by the optical assembly. In some embodiments, the plurality of windows may comprise 2 windows. In other embodiments, the plurality of windows may comprise 3 windows. In some embodiments, the center window of the plurality of windows may be oriented parallel to the area being observed by the optical assembly (e.g. a railroad) such that the long edge of the detecting optical assembly is parallel to the center window. In some embodiments, the plurality of windows may define the range of the field of view of the optical assembly. In some embodiments, the range of the field of view may be larger in a horizontal direction than in a vertical direction.

In some embodiments, the system of the present invention may comprise a field stop aperture disposed above the plurality of windows. In some embodiments, the imaging device implemented in the optical assembly of the present invention may comprise a wide-angle uncooled infrared (UCIR) camera. In some embodiments, the imaging device of the optical assembly of the present invention may comprise a lens. In some embodiments, the lens may comprise a retro-focus lens. In some embodiments, the lens may comprise a reverse telephoto lens. The optical assembly may further comprise a rotating gimbal, configured to rotate the field of view of the imaging device to effectively freeze motion of the tracked object. In some embodiments, the optical assembly may comprise an integral coude mirror assembly for aligning the gut ray of the imaging device on a rotation axis.

In some embodiments the moving object may be imaged at its speed by using a sequence of cameras having overlapping fields of view, sequential start times for exposure (integrating signal at focal plane array pixels) and minimally overlapping integration times such that successive subtractions of image data can be used to synthesize a short exposure and accomplish “high speed” imaging through the use of electronic and optical timing across multiple devices.

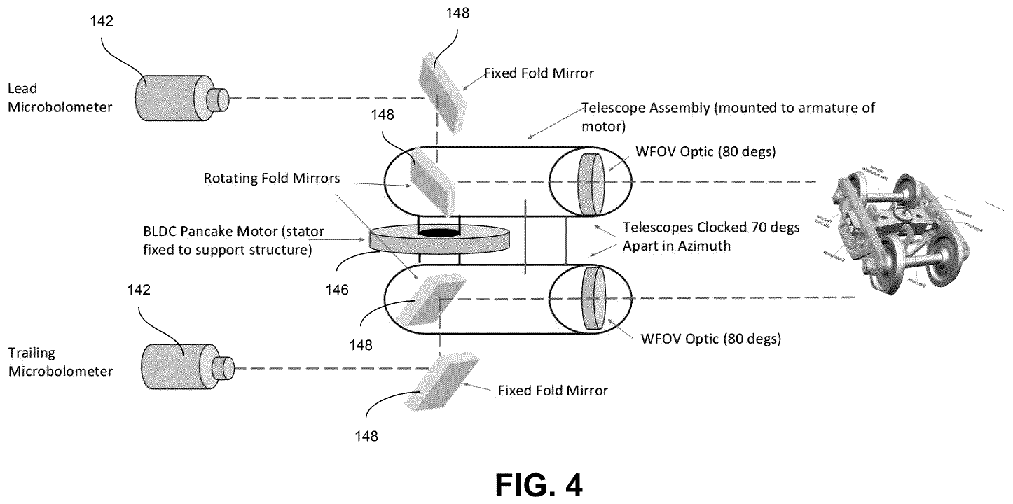

As seen in FIG. 4, in some embodiments, the optical assembly may comprise a plurality of imaging devices. In some embodiments, the plurality of imaging devices may comprise a lead microbolometer and a trailing microbolometer. The optical assembly may further comprise a plurality of fixed-fold mirrors. Each fixed fold mirror may be optically in-line with an imaging device of the plurality of imaging devices that may constitute a Coude' optical assembly. The optical assembly may comprise a brushless direct-current (BLDC) pancake motor. The optical assembly may further comprise a plurality of rotating fold mirrors operatively coupled to the BLDC pancake motor. Each rotating fold mirror may be optically in-line with a fixed fold mirror of the plurality of fixed fold mirrors. Each rotating fold mirror of the plurality of rotating fold mirrors may be disposed in a telescope assembly mounted to an armature of the BLDC pancake motor. In some embodiments, the telescopic assemblies may be clocked 100 degrees apart in azimuth. Each telescope assembly may further comprise a wide field-of-view optics having a threshold of 80 degrees and an objective focal length of 94 degrees.

In some embodiments, the retro-focus lens may comprise a fully spherical design. In some embodiments, the retro-focus lens may comprise a germanium material. In some embodiments, the fold mirrors of the optical assembly may comprise a fused silica material. In some embodiments, the optical assembly may further comprise a field stop disposed near the imaging device. In some embodiments, the optical assembly may comprise a mechanical stop operatively coupled to each rotating fold mirror to define a rotation range of each rotating fold mirror.

In some embodiments, the present invention may implement a plurality of windows because a single flat window cannot be used since the rays will experience total internal reflect (TIR) at modest scan angles due to the wide field of view. Minimization of seams over the full field of view normal to tracks may produce a 3 segmented window design. The detector being fixed and off-gimbal produces a rotating image plane as the gimbal tracks the moving object through the field of view during the time that object velocity and gimbal tangential velocity are comparable.

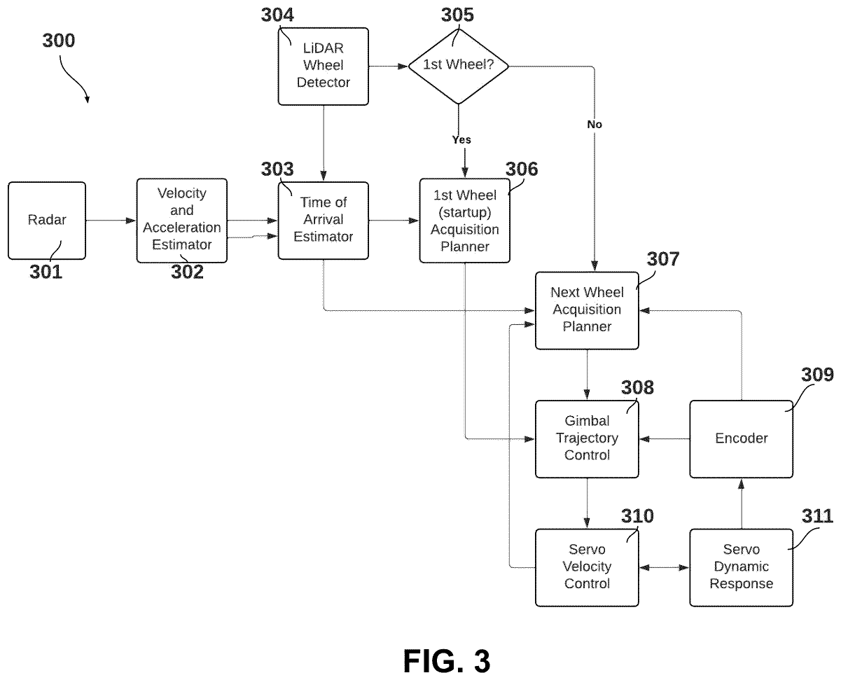

Referring now to FIG. 3, in some embodiments, the system of the present invention may comprise a velocity sensor configured to measure a velocity of a wheel of a train car. The velocity sensor may comprise a radar sensor (301). The velocity sensor may be communicatively coupled to a computing device (302) configured to estimate, based on the velocity measurement, the velocity and acceleration of the wheel. The system of the present invention may further comprise a localization sensor configured to detect a location of the wheel. The localization sensor may comprise a lidar sensor (304). The velocity estimate, the acceleration estimate, and the location of the wheel may be used to estimate, by a time-of-arrival estimator (303), a time of arrival (ToA) of the object relative to the optical assembly. Upon localizing the wheel, if the wheel is the first wheel (305) then the gimbal trajectory is set by a first wheel acquisition planner (306). The velocity of the servo of the motor is determined by the servo velocity control (310) and rotated according to the gimbal trajectory. If the wheel is not the first wheel, then the trajectory and velocity determined from the first wheel is used by the next wheel acquisition planner (307) to accurately track the current wheel. The trajectory and velocity of the motor may be adjusted based on each wheel that is tracked. The system may further comprise an encoder (309) communicatively coupled to the servo of the motor such that the gimbal trajectory (308) can be continuously adjusted based on a dynamic response of the servo (311).

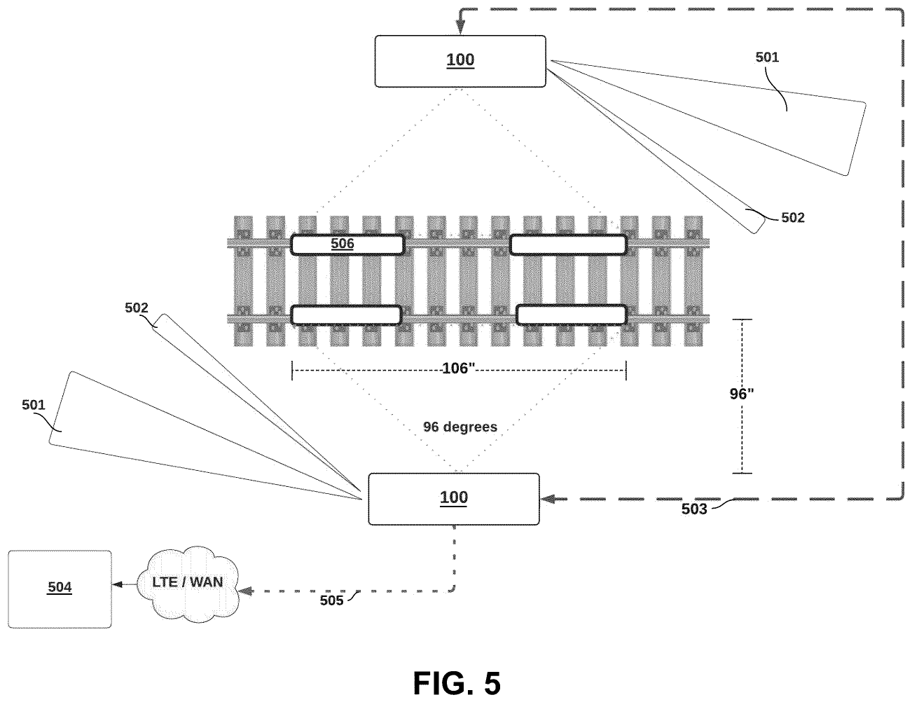

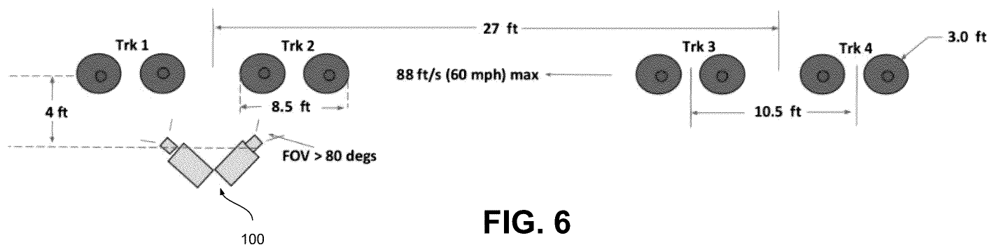

Referring now to FIG. 5, in some embodiments, the localization sensor may be a fixed, short-range laser range finder with narrow field of view (502) to sense wheel passage (506) and synchronize the servo of the motor pointing command with an approaching set of wheels (e.g. a first set of wheels, a subsequent set of wheels). In some embodiments, the velocity sensor may comprise a wide-band frequency-modulated continuous-wave (FMCW) radar sensor with a narrow beamwidth (501), understanding that “narrow” for radar and LiDAR are not the same thing, to minimize the probability of detecting false targets. In some embodiments, the imaging device may comprise a wide field-of-view microbolometer on an azimuth-only servo assembly. In some embodiments, the computing resources within the invention (100) may be communicated over a wide area network (WAN) via a wireless connection (505) or via a wired network connection, either of which may further find an endpoint in a cloud services provider (504) in communication with the WAN. In some embodiments, each object tracking and imaging station (100) may be connected to another object tracking and imaging station (100) by a wired or wireless connection (503).

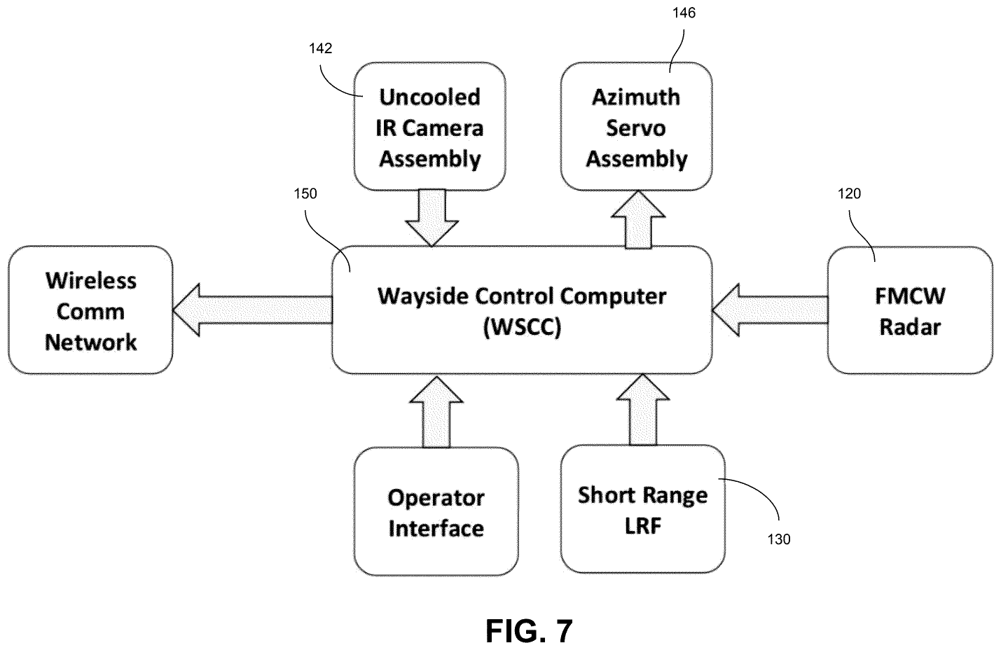

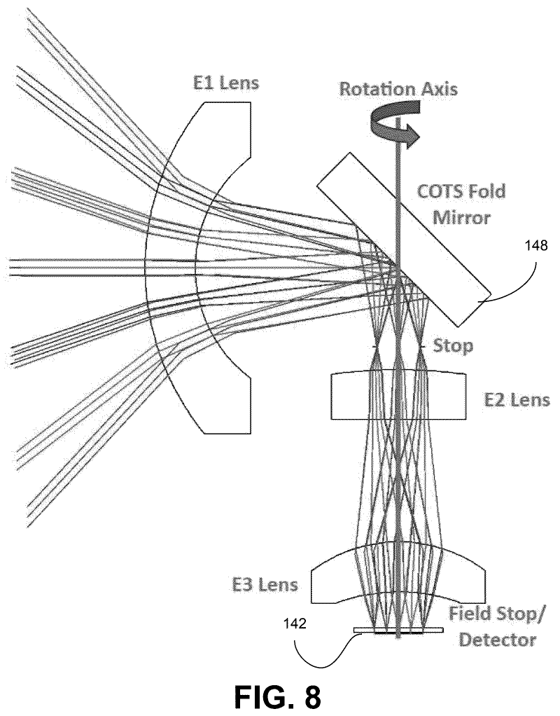

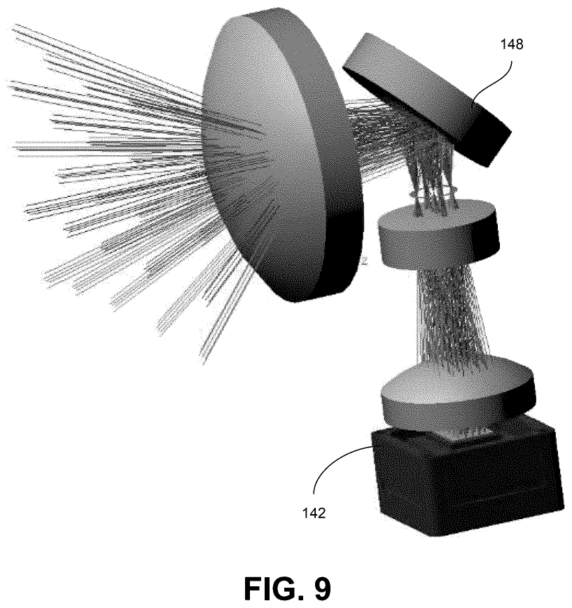

Referring now to FIG. 7, in some embodiments, the system may comprise a control computer. The control computer may be communicatively coupled to the imaging device (e.g an uncooled infrared camera assembly). The control computer may receive the one or more images captured by the imaging device as input for analysis and monitoring of the object being tracked. The control computer may be communicatively coupled to the localization sensor (e.g. a short range laser range finder). The control computer may also be communicatively coupled to the velocity sensor (e.g. a FMCW radar sensor). The control computer may also be communicatively coupled to the motor of the optical assembly (e.g. an azimuth servo assembly). The control computer may receive the velocity and location of the object being tracked and control the motor of the optical assembly accordingly. In some embodiments, the control computer may be communicatively coupled to an operator interface, configured to allow a user to view and manually operate the functions of the system. The control computer may be communicatively coupled to a wireless communication network. The control computer may transmit the images and function of the optical assembly and motor to a database over the wireless communication network. The control computer may additionally connect to other object imaging, tracking, and monitoring systems through the wireless communication network.

In some embodiments, FMCW Radar may detect oncoming trains, measure ranges and velocity, estimate acceleration to predict time of arrival. The servo for the uncooled infrared (IR) camera may first slew to its initial position for interception and then reverse the direction to slew in the direction of the train. For a given distance from the imaging system to track, the field of view (FOV) of the IR sensor needs to be large enough to image one or more wheel trucks from adjoining cars (otherwise the rate and accelerations imposed on the servo may be too large). During measurement, the servo may slew in the direction of the train at the required line of sight rate to stabilize the image. The LiDAR (sometimes “LRF” or laser range finder) may sense the next set of wheel trucks that are about to pass which is then used by the control computer to ‘plan’ the next intercept. Only stabilized IR images are collected. Image processing by the system computer may detect ‘hot spots’ and wirelessly communicate alerts to the train operator as required. The image processing may be limited to a region of vertical space that contains axles to limit false alarms.

In some embodiments, the high speed images may be used as part of a signal processing chain that seeks to produce a thermographic wheel and time sequence that can be associated with a car and wheel manifest, such as the following example of a processing algorithm. The algorithm may comprise acquiring and updating velocity and position data, adjusting acquisition settings, capturing images on frame sync, registering images, combining and deblurring the image data, locating objects and extra thermographic data for objects, buffering object data as a list by car and wheel, acquiring car and wheel manifest, reconciling car and wheel data with thermographic data, storing in a database (local or cloud), and forwarding to a network operations center (NOC)/security operations center (SOC) server

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer-readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft® .NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A stationary sensing system (100) configured to analyze a passing high-velocity object (200), the system (100) comprising:
a. a stationary housing (110);
b. a velocity sensor (120) configured to detect a velocity of the object (200);
c. a localization sensor (130) configured to detect a location of the object (200);
d. an optical assembly (140) disposed within the stationary housing (110), communicatively coupled to the velocity sensor (120) and the localization sensor (130), the assembly (140) comprising:
i. one or more uncooled imaging devices (142) having a collective moving field of view, configured to capture one or more images within the collective moving field of view; and
ii. a controller (144) operatively coupled to the one or more uncooled imaging devices (142), configured to accept the velocity from the velocity sensor (120) and the location from the localization sensor (130), actuate the one or more uncooled imaging devices (142) such that the collective moving field of view of the one or more uncooled imaging devices (142) locks to the location of the object (200) and rotates at a velocity matching the velocity of the object (200), and actuate the one or more uncooled imaging devices (142) to capture the one or more images within the collective moving field of view such that the one or more images capture the object (200); and
e. a computing device (150) communicatively coupled to the optical assembly (140), configured to accept the one or more images from the one or more uncooled imaging devices (142) and analyze one or more properties of the object (200) based on the one or more images.

2. The system (100) of claim 1, wherein the one or more uncooled imaging devices (142) comprise one or more thermal cameras, one or more red-green-blue (RGB) cameras, or a combination thereof.

3. The system (100) of claim 1, wherein the one or more uncooled imaging devices (142) comprise a plurality of uncooled imaging devices arranged in series, wherein rotating the collective moving field of view comprises actuating each uncooled imaging device of the plurality of uncooled imaging devices in series.

4. The system (100) of claim 1, wherein the one or more uncooled imaging devices (142) comprise a single uncooled imaging device, wherein the system (100) further comprises a motor (146), wherein the controller (144) is further configured to actuate the motor (146) to rotate the collective moving field of view.

5. The system (100) of claim 4, wherein the motor (146) is operatively coupled to the single uncooled imaging device and is configured to rotate the single uncooled imaging device.

6. The system (100) of claim 4, wherein the system (100) further comprises one or more optical elements (148) optically in-line with the single uncooled imaging device, wherein the motor (146) is operatively coupled to the one or more optical elements (148) and is configured to rotate the one or more optical elements (148).

7. The system (100) of claim 6, wherein the one or more optical elements (148) comprise a Coudé optical arrangement.

8. The system (100) of claim 1, wherein the velocity sensor (120) comprises a radar sensor.

9. The system (100) of claim 1, wherein the localization sensor (130) comprises a lidar sensor.

10. The system (100) of claim 1, wherein the computing device (150) is further communicatively coupled to one or more additional stationary sensing systems, wherein the computing device (150) is further configured to accept one or more additional images of the object (200) from the one or more additional stationary sensing systems and analyze the one or more properties based on the one or more images and the one or more additional images.

11. The system (100) of claim 1, wherein the computing device (150) is further configured to correct the one or more images for barrel distortion, distortions in focal length and field of view in an x direction, distortion in focal length and field of view in a y direction, root-mean-square wavefront errors, modulation transfer function degradation, or a combination thereof.

12. A stationary sensing system (100) configured to analyze a passing high-velocity object (200), the system (100) comprising:
a. a stationary housing (110);
b. a velocity sensor (120) configured to detect a velocity of the object (200);
c. a localization sensor (130) configured to detect a location of the object (200);
d. an optical assembly (140) disposed within the stationary housing (110), communicatively coupled to the velocity sensor (120) and the localization sensor (130), the assembly (140) comprising:
i. an uncooled imaging device (142) having a moving field of view, configured to capture one or more images within the moving field of view;
ii. a motor (146) operatively coupled to the uncooled imaging device (142), configured to rotate the uncooled imaging device (142); and
iii. a controller (144) operatively coupled to the uncooled imaging device (142), configured to accept the velocity from the velocity sensor (120) and the location from the localization sensor (130), actuate the motor (146) to rotate the uncooled imaging device (142) such that the moving field of view of the uncooled imaging device (142) locks to the location of the object (200) and rotates at a velocity matching the velocity of the object (200), and actuate the uncooled imaging device (142) to capture the one or more images within the moving field of view such that the one or more images capture the object (200); and
e. a computing device (150) communicatively coupled to the optical assembly (140), configured to accept the one or more images from the uncooled imaging device (142) and analyze one or more properties of the object (200) based on the one or more images.

13. The system (100) of claim 12, wherein the uncooled imaging device (142) comprises a thermal camera, a red-green-blue (RGB) camera, or a combination thereof.

14. The system (100) of claim 12, wherein the velocity sensor (120) comprises a radar sensor.

15. The system (100) of claim 12, wherein the localization sensor (130) comprises a lidar sensor.

16. The system (100) of claim 12, wherein the computing device (150) is further communicatively coupled to one or more additional stationary sensing systems, wherein the computing device (150) is further configured to accept one or more additional images of the object (200) from the one or more additional stationary sensing systems and analyze the one or more properties based on the one or more images and the one or more additional images.

17. The system (100) of claim 12, wherein the computing device (150) is further configured to correct the one or more images for barrel distortion, distortions in focal length and field of view in an x direction, distortion in focal length and field of view in a y direction, root-mean-square wavefront errors, modulation transfer function degradation, or a combination thereof.

18. A stationary sensing system (100) configured to analyze a passing high-velocity object (200), the system (100) comprising:
a. a stationary housing (110);
b. a velocity sensor (120) configured to detect a velocity of the object (200);
c. a localization sensor (130) configured to detect a location of the object (200);
d. an optical assembly (140) disposed within the stationary housing (110), communicatively coupled to the velocity sensor (120) and the localization sensor (130), the assembly (140) comprising:
i. an uncooled imaging device (142) having a moving field of view, configured to capture one or more images within the moving field of view;
ii. a plurality of optical elements (148) optically in-line with the uncooled imaging device (142), in a Coudé arrangement;
iii. a motor (146) operatively coupled to the plurality of optical elements (148), configured to rotate the plurality of optical elements (148); and
iv. a controller (144) operatively coupled to the uncooled imaging device (142), configured to accept the velocity from the velocity sensor (120) and the location from the localization sensor (130), actuate the motor (146) to rotate the plurality of optical elements (148) such that the moving field of view of the uncooled imaging device (142) locks to the location of the object (200) and rotates at a velocity matching the velocity of the object (200), and actuate the uncooled imaging device (142) to capture the one or more images within the moving field of view such that the one or more images capture the object (200); and
e. a computing device (150) communicatively coupled to the optical assembly (140), configured to accept the one or more images from the uncooled imaging device (142) and analyze one or more properties of the object (200) based on the one or more images.

19. The system (100) of claim 18, wherein the velocity sensor (120) comprises a radar sensor.

20. The system (100) of claim 18, wherein the localization sensor (130) comprises a lidar sensor.
